(19) United States
(12) Patent Application Publication
(10) Pub. No.: US 2012/0150887 A1
(43) Pub. Date: Jun. 14, 2012

(54) PATTERN MATCHING

(76) Inventors: Christopher F. Clark, Chandler, AZ (US); Vinodh Gopal, Westborough, MA (US); Gilbert M. Wolrich, Framingham, MA (US)

(21) Appl. No.: 12/963,438

(22) Filed: Dec. 8, 2010

(51) Int. Cl. G06F 17/30

(52) U.S. Cl. 707/758; 707/E17.005

(57) ABSTRACT

An embodiment may include circuitry to determine, at least in part, whether one or more reference patterns are present in a data stream in a packet flow. The circuitry may include first pattern matching circuitry communicatively coupled to second pattern matching circuitry. The first pattern matching circuitry may determine, based at least in part upon one or more deterministic pattern matching operations, whether at least one portion of the one or more reference patterns is present in the stream. If the first pattern matching circuitry determines that the at least one portion of the one or more reference patterns is present in the stream, the second pattern matching circuitry may determine, based at least in part upon one or more pattern matching threads, whether at least one other portion of the one or more reference patterns is present in the stream. Many modifications are possible without departing from this embodiment.

### FIELD

This disclosure relates to pattern matching.

### BACKGROUND

In one type of conventional arrangement, a first host receives packets from a second host via a network. Software agents executed by, in association with, and/or as part of the operating system in the first host implement malicious program (e.g., virus) detection operations with respect to the received packets. Such detection operations involve comparison of received packet data with patterns indicative of malicious programs. Unfortunately, in this conventional arrangement, as a result of the agents being software processes that rely upon the operating system, the agents themselves and their operations may be relatively easily tampered with by the malicious programs. Also, if the agents are executed by the first host's host processor, an undesirably large amount of the host processor's processing bandwidth, as well as, an undesirably large amount of processing time may be consumed by these agents.

One proposed solution involves use of deterministic finite automata (DFA) hardware to carry out detection-related operations. However, given the relatively large pattern databases that may be used in such operations, the resulting DFA hardware may utilize more memory and be larger that is desirable. Although non-deterministic finite automata (NFA) may utilize less memory and may be smaller than a corresponding DFA, a conventional NFA may operate more slowly than desired.

### BRIEF DESCRIPTION OF THE SEVERAL VIEWS OF THE DRAWINGS

Features and advantages of embodiments will become apparent as the following Detailed Description proceeds, and upon reference to the Drawings, wherein like numerals depict like parts, and in which:

FIG. 1 illustrates a system embodiment.

FIG. 2 illustrates pattern matching circuitry in an embodiment.

FIG. 3 illustrates operations in an embodiment.

FIG. 4 illustrates features in an embodiment.

FIG. 5 illustrates features in an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

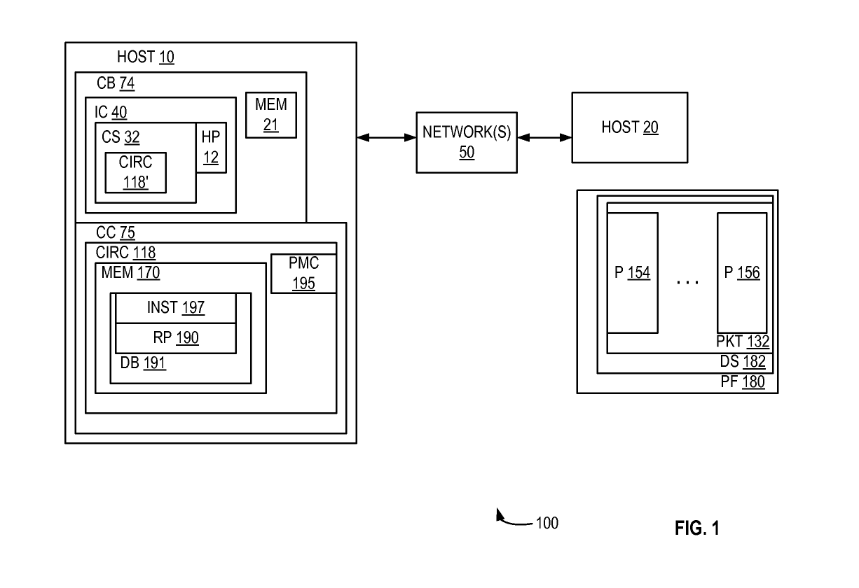

FIG. 1 illustrates a system embodiment 100. System 100 may include one or more hosts 10 communicatively coupled to one or more hosts 20 via one or more networks 50. In this embodiment, the term “host” may mean, for example, one or more end stations, appliances, intermediate stations, network interfaces, clients, servers, and/or portions thereof. Although one or more hosts 10, one or more hosts 20, and one or more networks 50 will be referred to hereinafter in the singular, it should be understood that each such respective component may comprise a plurality of such respective components without departing from this embodiment. In this embodiment, a “network” may be or comprise any mechanism, instrumentality, modality, and/or portion thereof that permits, facilitates, and/or allows, at least in part, two or more entities to be communicatively coupled together. Also in this embodiment, a first entity may be “communicatively coupled” to a second entity if the first entity is capable of transmitting to and/or receiving from the second entity one or more commands and/or data. In this embodiment, data may be or comprise one or more commands (such as for example one or more program instructions), and/or one or more such commands may be or comprise data. Also in this embodiment, an “instruction” may include data and/or one or more commands.

Host 10 may comprise circuit board (CB) 74 and circuit card (CC) 75. In this embodiment, CB 74 may comprise, for example, a system motherboard and may be physically and communicatively coupled to CC 75 via a not shown bus connector/slot system. CB 74 may comprise one or more integrated circuits (IC) 40 and computer-readable/writable memory 21. In this embodiment, each of the one or more IC 40 may be embodied as, for example, one or more semiconductor modules, chips, and/or substrates. One or more IC 40 may comprise one or more host processors (HP) 12 and one or more chipsets (CS) 32. One or more HP 12 may be communicatively coupled via one or more CS 32 to memory 21 and CC 75.

Each of the one or more HP 12 may comprise, for example, a respective multi-core Intel® microprocessor. Of course, alternatively, each of the HP 12 may comprise a respective different type of microprocessor.

CC 75 may comprise circuitry 118. Circuitry 118 may comprise computer-readable/writable memory 170 and pattern matching circuitry (PMC) 195. Memory 170 may store one or more databases (DB) 191.

Alternatively, as shown in FIG. 1, some or all of circuitry 118 and/or the functionality and components thereof may be comprised in, for example, circuitry 118′ that may be comprised in whole or in part in one or more CS 32. Further alternatively, some or all of circuitry 118 and/or the functionality and components thereof may be comprised in one or more HP 12. Also alternatively, one or more HP 12, memory 21, one or more CS 32, one or more IC 40, and/or some or all of the functionality and/or components thereof may be comprised in, for example, circuitry 118 and/or CB 75. In another alternative arrangement, some or all of the functionality and/or components of one or more CS 32 may be comprised in one or more HP 12, or vice versa. Many other alternatives are possible without departing from this embodiment.

Although not shown in the Figures, host 20 may comprise, in whole or in part, the components and/or functionality of host 10. Alternatively, host 20 may comprise components and/or functionality other than and/or in addition to the components and/or functionality of host 10.

As used herein, “circuitry” may comprise, for example, singly or in any combination, analog circuitry, digital circuitry, hardwired circuitry, programmable circuitry, co-processor circuitry, state machine circuitry, and/or memory that may comprise program instructions that may be executed by programmable circuitry. Also, in this embodiment, a “host processor,” “processor,” “processor core,” “core,” and “co-processor,” each may comprise respective circuitry capable of performing, at least in part, one or more arithmetic and/or logical operations, such as, for example, one or more respective central processing units. Also in this embodiment, a “chipset” may comprise circuitry capable of communicatively coupling, at least in part, one or more HP, storage, mass storage, one or more hosts, and/or memory. Although not shown in the Figures, host 10 and/or host 20 each may comprise a respective graphical user interface system. Each such graphical user interface system may comprise, e.g., a respective keyboard, pointing device, and display system that may permit a human user to input commands to, and monitor the operation of, host 10, host 20, and/or system 100.

One or more machine-readable program instructions may be stored in computer-readable/writable memory 21 and/or circuitry 118. In operation of host 10, these instructions may be accessed and executed by one or more HP 12, circuitry 118, and/or PMC 195. When executed by one or more HP 12, circuitry 118, and/or PMC 195, these one or more instructions may result in one or more HP 12, circuitry 118, and/or PMC 195 performing the operations described herein as being performed by one or more HP 12, circuitry 118, and/or PMC 195. In this embodiment, “memory” may comprise one or more of the following types of memories: semiconductor firmware memory, programmable memory, non-volatile memory, read only memory, electrically programmable memory, random access memory, flash memory, magnetic disk memory, optical disk memory, and/or other or later-developed computer-readable and/or writable memory.

In this embodiment, host 10 and host 20 may be geographically remote from each other. Circuitry 118 and/or one or more CS 32 may be capable of exchanging data and/or commands with host 20 via network 50 in accordance with one or more protocols. These one or more protocols may be compatible with, e.g., an Ethernet protocol and/or Transmission Control Protocol/Internet Protocol (TCP/IP).

The Ethernet protocol that may be utilized in system 100 may comply or be compatible with the protocol described in Institute of Electrical and Electronics Engineers, Inc. (IEEE) Std, 802.3, 2000 Edition, published on Oct. 20, 2000. The TCP/IP that may be utilized in system 100 may comply or be compatible with the protocols described in Internet Engineering Task Force (IETF) Request For Comments (RFC) 791 and 793, published September 1981. Of course, many different, additional, and/or other protocols may be used for such data and/or command exchange without departing from this embodiment, including for example, later-developed versions of the aforesaid and/or other protocols.

In this embodiment, host 20 may transmit to host 10 via network 50 one or more packet flows (PF) 180. One or more PF 180 may comprise one or more data streams (DS) 182. One or more DS 182 may comprise a plurality of packets, including, as shown in FIG. 1, one or more packets 132. In this embodiment, one or more packets 132 may comprise one or more portions 154 and one or more portions 156. In operation of system 100, circuitry 118 may receive one or more PF 180 from network 50.

In this embodiment, a packet may comprise one or more symbols and/or values. Also in this embodiment, a fragment of a packet and a packet may be used interchangeably and may comprise some or all of a packet and/or one or more contiguous or non-contiguous portions of a packet. In this embodiment, a “portion” or “subset” of an entity may comprise some or all of that entity.

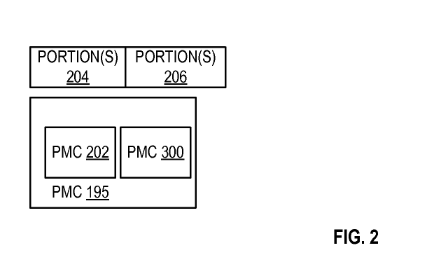

As shown in FIG. 2, in this embodiment, PMC 195 may comprise PMC 202 and PMC 300. After or contemporaneously with receipt, at least in part, of one or more flows 180, circuitry 118 may determine, at least in part, whether one or more reference patterns (RP) are present in one or more DS 182. In this embodiment, this determination, at least in part, by circuitry 118 may be carried out, at least in part, by PMC 202 and 300. In this embodiment, a pattern may comprise one or more contiguous or non-contiguous symbols and/or values. Also in this embodiment, one or more RP 190 may embody, comprise, and/or be indicative and/or characteristic of, at least in part, one or more malicious, unauthorized, and/or undesired instructions and/or data (e.g., virus code and/or data). Therefore, the presence of one or more RP 190 in one or more DS 182 may indicate, at least in part, that one or more such instructions and/or data are present, at least in part, in one or more DS 182.

PMC 202 may be communicatively coupled to PMC 300. PMC 202 may determine, based at least in part upon one or more deterministic pattern matching operations executed at least in part by circuitry 202 whether one or more portions 204 of one or more RP 190 are present in one or more DS 182. If PMC 202 determines that one or more portions 204 are present in one or more DS 182, PMC 300 may determine, based at least in part upon one or more pattern matching threads (e.g., that execute and/or result from, at least in part, one or more multithreaded pattern matching operations executed at least in part by circuitry 300), whether one or more other portions 206 of these one more RP 190 are present in the one or more DS 182. In this embodiment, one or more portions 154 and/or one or more portions 156 of one or more packets 132 may correspond, at least in part, to one or more portions 204 and/or one or more portions 206 of stream 182.

In this embodiment, a deterministic operation may be (but is not required to be) implementable, at least in part, by DFA and/or state machine circuitry, and/or by and/or as a result, at least in part, of one or more predetermined algorithms. In this embodiment, circuitry 202 may be or comprise DFA state machine circuitry. Circuitry 300 may be or comprise NFA circuitry. Also in this embodiment, PMC 202 may comprise a relatively faster comparison path for purposes of pattern matching relative to the comparison path embodied by PMC 300. This may result, at least in part, from PMC 202 comprising relatively faster, but less detailed and/or programmatically powerful, set-wise and/or fixed string pattern matching circuitry, as compared to PMC 300. PMC 300, on the other hand, may comprise relatively slower, multithreaded very large instruction word logic circuitry 305 that may be capable of performing relatively more detailed and programmatically powerful deterministic regular expression pattern matching operations than PMC 202 is capable of performing. For example, circuitry 202 and/or circuitry 300 may comprise, at least in part, respectively analogous and/or similar types of circuitry, at least in part, to those described in co-pending U.S. patent application Ser. No. 12/637,488 filed Dec. 14, 2009, entitled “Packet Boundary Spanning Pattern Matching Based At Least In Part Upon History Information.” Of course, this is merely exemplary, and without departing from this embodiment, circuitry 202 and/or 300 may comprise other and/or additional types and/or configurations of circuitry.

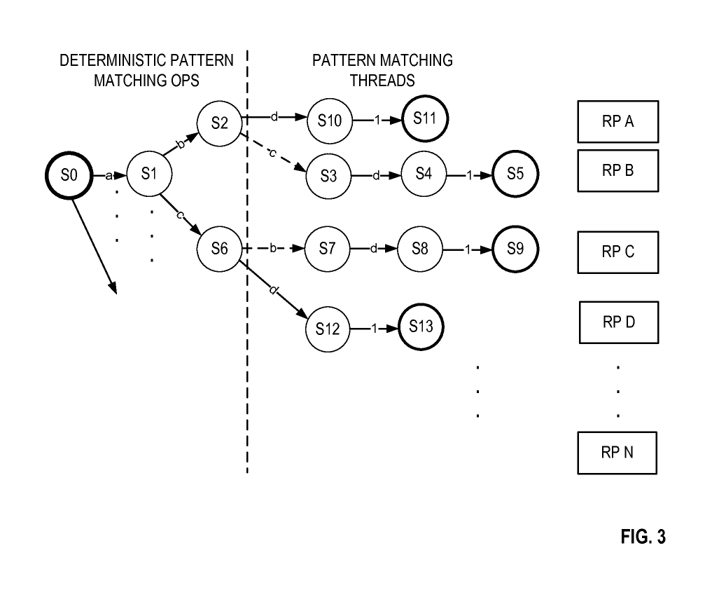

FIG. 3 illustrates examples of operations that may be carried out, at least in part, by circuitry 195 in connection with pattern matching in this embodiment. For example, the one or more deterministic pattern matching operations may implement, at least in part, one or more (and in this embodiment, a plurality of) states S0, S1, S2, and/or S6 of PMC 202. Also for example, the one or more pattern matching threads may implement, at least in part, one or more (and in this embodiment, a plurality of) states S3, S4, S5, S7, S8, S9, S10, S11, S12, and/or S13 of PMC 300. One or more states S0, S1, S2, and/or S6 of PIM 202 may be associated, at least in part, with one or more portions 204 of one or more reference patterns 190. One or more states S3, S4, S5, S7, S8, S9, S10, S11, S12, and/or S13 of PMC 300 may be associated, at least in part, with one or more portions 206 of the one or more reference patterns 190.

For example, one or more RP 190 may comprise RPA, RP B, RP C, RP D . . . RP N. Circuitry 202 and 300 may implement, at least in part, respective combinations of deterministic pattern matching operations and pattern matching threads, respectively, to detect RPA, RP B, RP C, RP D . . . RP N. For example, RP A may comprise patterns (symbolically illustrated in FIG. 3 as “a b d”), RP B may comprise patterns “a b c d”, RP C may comprise patterns “a c b d”, and RP D may comprise patterns “a c d”, respectively.

In the case of RP A and RP B, one or more portions 204 of stream 182 may comprise patterns “a b”, and PMC 202 may be capable of detecting, at least in part, based at least in part upon one or more deterministic pattern matching operations, patterns “a b”. In the case of RP C and RP D, one or more portions 204 of stream 182 may comprise patterns “a c”, and PMC 202 may be capable of detecting, at least in part, based at least in part upon one or more deterministic pattern matching operations, patterns “a c”.

In the case of RP A and RP D, one or more portions 206 of stream 182 may comprise one or more patterns “d”, and PMC 300 may be capable of detecting, at least in part, based at least in part upon one or more pattern matching threads, one or more patterns “d”. In the case of RP B, one or more portions 206 of stream 182 may comprise patterns “c d”, and PMC 300 may be capable of detecting, at least in part, based at least in part upon one or more pattern matching threads, one or more patterns “c d”. In the case of RP C, one or more portions 206 of stream 182 may comprise patterns “b d”, and PMC 300 may be capable of detecting, at least in part, based at least in part upon one or more pattern matching threads, one or more patterns “b d”.

The detection (or non-detection) of a respective pattern comprised in one or more of the RP 190 may result, at least in part, in circuitry 202 and/or 300 transitioning to one or more states associated, at least part, with the respective pattern. For example, circuitry 202 may be initialized in initial state S0. Thereafter, if circuitry 202 detects, at least in part, in one or more portions 204, one or more patterns “a”, circuitry 202 may transition to a subsequent state S1. Thereafter, if the next pattern present in one or more portions 204 (e.g., after one or more patterns “a”) corresponds, at least in part, to one or more patterns “b”, then circuitry 202 may transition to subsequent state S2. Conversely, after entering state S\, if the next pattern present in one or more portions 204 corresponds, at least in part, to one or more patterns “c”, then circuitry 202 may transition to subsequent state S6. Also conversely, if, after entering state S1, the next pattern present in one or more portions 204 does not correspond, at least in part, to one or more patterns “b” or “c”, then circuitry 202 may transition to a subsequent state (not shown) of circuitry 202 that may correspond to the processing stage of state S1, and may be associated, at least in part, with the next pattern that is present in one or more portions 204. If no such subsequent state corresponding to the processing stage of state S1 is associated, at least in part, with this next pattern, circuitry 202 may transition back to initial state S0.

In this example, after circuitry 202 has entered state S2, circuitry 202 may perform one or more hashing operations (e.g., comprising one or more checksum and/or cyclic redundancy check (CRC) calculations, hereinafter collectively and/or singly referred to as checksum calculation) to calculate one or more hashes based at least in part upon and/or of a plurality of inputs from one or more portions 206 of stream 182. For example, in this embodiment, these inputs may comprise a plurality of patterns that may be actually present in one or more portions 206. Circuitry 202 may compare, at least in part, the resulting one or more hashes to one or more expected values. These one or more expected values may be or comprise one or more hash values that result, at least in part, from performing one or more similar or identical hashing operations based at least in part upon and/or of a plurality of state transition inputs (e.g., patterns, such as, patterns “c d”) that are comprised, at least in part, in one or more RP) (e.g., RP B). Circuitry 202 may determine, at least in part, whether these one or more hashing and/or comparison related operations result in the one or more expected values (e.g., whether the one or more hashes calculated from inputs from one or more portions 206 match the one or more expected values). These one or more hashing, comparison, and/or determination operations are symbolically illustrated in FIG. 3 by the dashed arrow between states S2 and S3. If circuitry 202 determines, at least in part, that such a match exists, circuitry 202 may indicate, at least in part, to circuitry 300 that circuitry 202 has determined, at least in part, that one or more portions (e.g., patterns “a b”) of one or more RP (e.g., RP B) is present in one or more portions 204 of stream 182.

In response, at least in part, to such determination and/or indication, at least in part, by circuitry 202, circuitry 300 may examine, at least in part, one or more portions 206 to determine, at least in part, whether one or more patterns (e.g., one or more patterns “c”) comprised in one or more RP (e.g., RP B) are present in one or more portions 206 of stream 182. If circuitry 300 determines, at least in part, that one or more such patterns “c” are present in one or more portions 206, circuitry 300 may transition to state S3. Thereafter, circuitry 300 may determine, at least in part, whether one or more additional patterns “d” comprised in one or more RP B are present in one or more portions 206. If circuitry 300 determines, at least in part, that one or more patterns “d” are present in one or more portions 206, circuitry 300 may determine, at least in part, that one or more portions (e.g., one or more patterns “c d”) of one or more RP B are present in data stream 182. Circuitry 300 then may transition to state S4, may indicate (symbolically referred to by the numeral “1” in FIG. 3) to circuitry 195, circuitry 118, CS 32, and/or HP 12 that one or more RP B are present in stream 182, and may transition to state S5.

Conversely, if, after circuitry 202 enters state S2, circuitry 202 determines, at least in part, that a match with the one or more expected hash values does not exist, circuitry 202 may indicate, at least in part, to circuitry 300 that circuitry 202 has determined, at least in part, that one or more portions (e.g., patterns “a b”) of one or more other RP (e.g., RP A) is present in one or more portions 204 of stream 182. In response, at least in part, to such determination and/or indication, at least in part, by circuitry 202, circuitry 300 may examine, at least in part, one or more portions 206 to determine, at least in part, whether one or more patterns (e.g., one or more patterns “d”) comprised in one or more RP (e.g., RP A) are present in one or more portions 206 of stream 182. If circuitry 300 determines, at least in part, that one or more such patterns “d” are present in one or more portions 206, then circuitry 300 may determine, at least in part, that one or more portions (e.g., one or more patterns “d”) of one or more RP A are present in data stream 182. Circuitry 300 then may transition to state S10, may indicate (symbolically referred to by the numeral “1” in FIG. 3) to circuitry 195, circuitry 118, CS 32, and/or 12 that one or more RP A are present in stream 182, and may transition to state S11.

Conversely, if circuitry 202 enters state S6, circuitry 202 may perform one or more hashing operations (e.g., comprising one or more checksum calculations) to calculate one or more hashes based at least in part upon and/or of a plurality of inputs from one or more portions 206 of stream 182 that may be associated, at least in part, with one or more other RP (e.g., RP C). For example, in this embodiment, these inputs may comprise a plurality of patterns that may be actually present in one or more portions 206. Circuitry 202 may compare, at least in part, the resulting one or more hashes to one or more expected values. These one or more expected values may be or comprise one or more hash values that result, at least in part, from performing one or more similar or identical hashing operations based at least in part upon and/or of a plurality of state transition inputs (e.g., patterns, such as, patterns “b d”) that are comprised, at least in part, in one or more RP C. Circuitry 202 may determine, at least in part, whether these one or more hashing and/or comparison related operations result in the one or more expected values (e.g., whether the one or more hashes calculated from inputs from one or more portions 206 match the one or more expected values). These one or more hashing, comparison, and/or determination operations are symbolically illustrated in FIG. 3 by the dashed arrow between states S6 and S7. If circuitry 202 determines, at least in part, that such a match exists, circuitry 202 may indicate, at least in part, to circuitry 300 that circuitry 202 has determined, at least in part, that one or more portions (e.g., patterns “a c”) of one or more RP (e.g., RP C) is present in one or more portions 204 of stream 182.

In response, at least in part, to such determination and/or indication, at least in part, by circuitry 202, circuitry 300 may examine, at least in part, one or more portions 206 to determine, at least in part, whether one or more patterns (e.g., one or more patterns “b”) comprised in one or more RP (e.g., RP C) are present in one or more portions 206 of stream 182. If circuitry 300 determines, at least in part, that one or more such patterns “b” are present in one or more portions 206, circuitry 300 may transition to state S7. Thereafter, circuitry 300 may determine, at least in part, whether one or more additional patterns “d” comprised in one or more RP C are present in one or more portions 206. If circuitry 300 determines, at least in part, that one or more patterns “d” are present in one or more portions 206, circuitry 300 may determine, at least in part, that one or more portions “b d” of one or more RP C are present in data stream 182. Circuitry 300 then may transition to state S8, may indicate (symbolically referred to by the numeral “1” in FIG. 3) to circuitry 195, circuitry 118, CS 32, and/or HP 12 that one or more RP C are present in stream 182, and may transition to state S9.

Conversely, if after circuitry 202 enters state S6, circuitry 202 determines, at least in part, that a match with the one or more expected hash values does not exist, circuitry 202 may indicate, at least in part, to circuitry 300 that circuitry 202 has determined, at least in part, that one or more portions (e.g., patterns “a c”) of one or more other RP (e.g., RP D) is present in one or more portions 204 of stream 182. In response, at least in part, to such determination and/or indication, at least in part, by circuitry 202, circuitry 300 may examine, at least in part, one or more portions 206 to determine, at least in part, whether one or more patterns (e.g., one or more patterns “d”) comprised in one or more RP (e.g., RP D) are present in one or more portions 206 of stream 182. If circuitry 300 determines, at least in part, that one or more such patterns “d” are present in one or more portions 206, then circuitry 300 may determine, at least in part, that one or more portions “d” of one or more RP D are present in stream 182. Circuitry 300 then may transition to state S12, may indicate (symbolically referred to by the numeral “1” in FIG. 3) to circuitry 195, circuitry 118. CS 32, and/or HP 12 that one or more RP D are present in stream 182, and may transition to state S13.

Conversely, if after receiving such indication from circuitry 202, circuitry 300 determines, at least in part, that one or more portions 206 do not comprise the one or more of the respective transition inputs “d”, “c”, “b”, “d”, “d”, or “d” associated, at least in part, with states S10, S3, S7, S12, S4, and/or S8, respectively, then circuitry 202 and/or circuitry 300 may return to their respective initial states. In this embodiment, circuitry 202 may perform the one or more hashing, comparison, and/or related determination operations described above in connection with patterns associated, at least in part, with transition inputs of chains of states of the circuitry 300 that do not exhibit internal branches and/or multiple respective transition inputs for a given respective state. The respective numbers and/or lengths of inputs used in such hashing operations may be identical or may vary from each other on a calculation-by-calculation (and/or other) basis, without departing from this embodiment.

Advantageously, by utilizing these hashing, comparison, and/or related determination operations, this embodiment may be capable of achieving more efficient string-matching and/or regular expression matching performance than might otherwise be achieved. For example, by utilizing such operations in this embodiment, the performance of circuitry 300 may be improved in situations in which (1) circuitry 300 might otherwise present a performance bottleneck in circuitry 195, (2) one or more cache misses might otherwise occur in connection with circuitry 300 attempting to detect one or more portions of one or more RP in one or more portions 206, and/or (3) an erroneous transition of processing from circuitry 202 to circuitry 300 might otherwise occur.

Returning to FIG. 3, in this embodiment, one or more states S1, S2, and/or S6 of circuitry 202 may be associated, at least in part, with one or more sets of transitions (e.g., state transitions) whose number may be greater than or equal to a predetermined threshold value. The one or more deterministic pattern matching operations of circuitry 202 may implement, at least in part, one or more states (e.g., S0 and/or S1) of circuitry 202 that may precede, at least in part, these one or more states S1, S2, and/or S6.

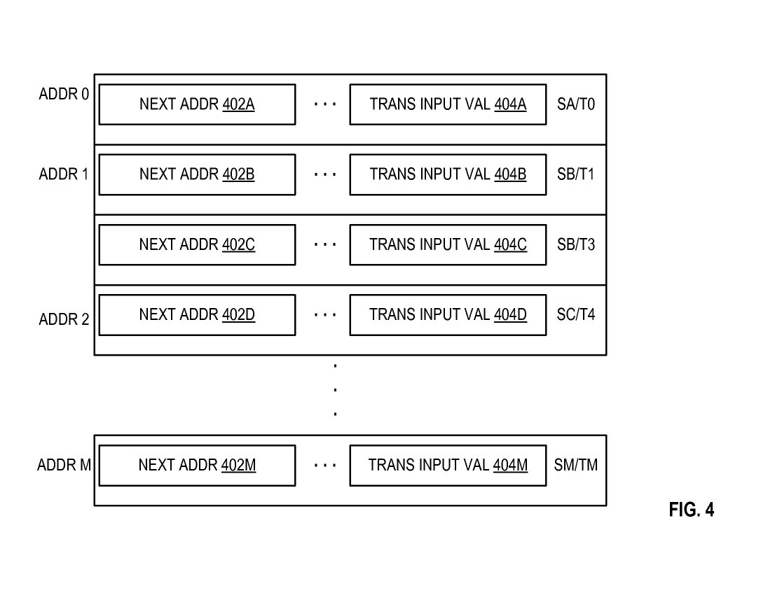

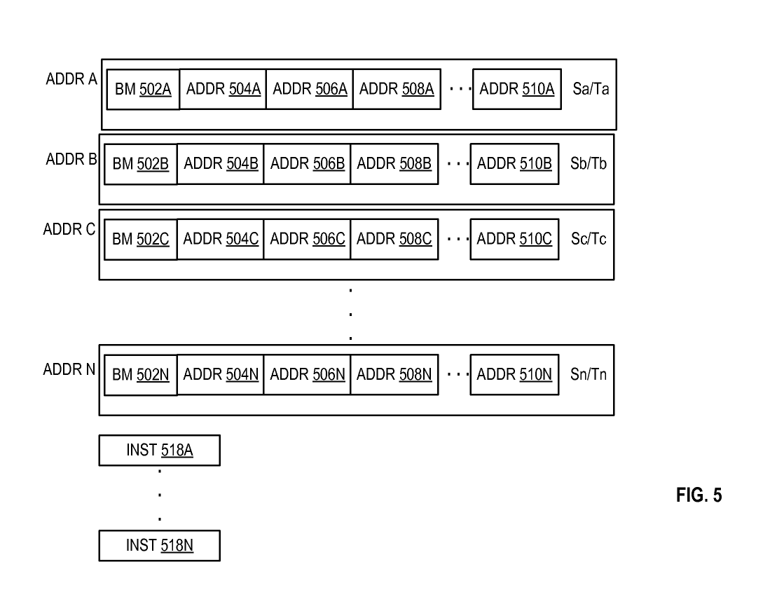

For example, in this embodiment, one or more compiler (and/or analogous or similar) operations may determine, at least in part, which respective sets of states shown in FIG. 3 may be implemented, at least in part, by circuitry 202 and 300, respectively. Additionally or alternatively, these one or more compiler operations may determine, at least in part, the hashing, comparison, and/or related determination operations that may be carried out, at least in part, by circuitry 202. These compiler operations also may generate, at least in part, the tuples shown in FIGS. 4 and 5 which may encode, at least in part, the one or more pattern matching threads and/or states that may be implemented, at least in part, by circuitry 300, and the one or more deterministic pattern matching operations and/or states that may be implemented, at least in part, by circuitry 202, respectively. Additionally, these compiler operations may consolidate, merge, and/or otherwise modify, at least in part, such states in order to improve performance of circuitry 202 and/or 300. In this regard, respective sets of states associated with detecting, at least in part, one or more RP 190 may be partitioned for performance by circuitry 202 and circuitry 300, respectively, in such a way as to permit circuitry 202 and 300 to perform respective sets of operations and/or implement respective sets of states that are best suited to be performed and/or implemented separately by circuitry 202 and 300, respectively. After such partitioning, each of the respective sets of states may be separately modified so to permit them to be most efficiently implemented by the particular circuitry (i.e., circuitry 202 or 300) that is to implement them.

For example, in selecting which states are to be implemented by circuitry 202, one or more states (e.g., S1, S2, and/or S6) that are associated with respective sets of transitions that are at least equal to a predetermined threshold value may be selected. In this simplified example, this threshold value may be equal to two transitions. However, in practical implementation, this threshold could be much larger, and may vary without departing from this embodiment. Thus, states S1, S2, and/or S6 may be selected since they each are associated with at least two respective transitions (e.g., S1 to S2 or to S6; S2 to S10 or S3; and S6 to S7 or to S12, respectively). Additionally or alternatively, one or more states (e.g., S0) that may precede (e.g., feed into) states S1, S2, and/or S6 may be selected for implementation by circuitry 202. Further additionally or alternatively, other and/or additional states may be selected for implementation by circuitry 202, so long as the resulting aggregation of states to be implemented by circuitry 202 does not result in the tuples shown in FIG. 5 consuming greater than a maximum desired amount of memory, and/or other desired design constraints being violated. After selecting the one or more states that are to be implemented by circuitry 202, one or more remaining states may be selected for implementation, at least in part, by circuitry 300.

Advantageously, in this embodiment, by utilizing the above techniques, the states to be implemented by circuitry 202 may be selected in such a way as to permit the memory utilized and/or consumed by circuitry 202 to be within maximum desired constraints. Additionally, these techniques may permit the respective numbers and characteristics of the respective sets of states implemented by circuitry 202 and 300, respectively, to be such that the respective sets of states may be best suited to be implemented by circuitry 202 and 300, respectively. This may permit circuitry 202 and 300 to execute their respective sets of states and/or operations more efficiently and/or faster than would otherwise be the case. Further, in this embodiment, these techniques may permit circuitry 202 to be optimized for processing speed and/or high transition fanout operations, while also permitting circuitry 300 to be optimized for memory space and/or low transition fanout operations. Advantageously, this may permit circuitry 195 to exhibit performance characteristics, memory consumption, and size that scale linearly with pattern match problem size, without suffering from drawbacks such as exponential increase of memory consumption or exponential decrease in performance.

Turning to FIG. 5, memory 170, one or more instructions 197, and/or database 191 may comprise, at least in part, one or more (and in this embodiment, a plurality of) tuples Ta . . . Tn. Each of the tuples Ta . . . Tn may be stored at one or more respective memory addresses ADDR A . . . ADDR N (e.g., in memory 170). One or more (and, in this embodiment, a plurality of) states (e.g., Sa . . . Sn) of circuitry 202 that may be associated, at least in part, with one or more portions of one or more RP 190 may be encoded, at least in part, as the one or more tuples Ta . . . Tn. The one or more deterministic pattern matching operations executed by circuitry 202 may implement, at least in part, one or more states Sa . . . Sn.

In this embodiment, the respective tuples Ta . . . Tn may include one or more respective bit masks (BM) 502A . . . 502N and one or more (and in this embodiment, a plurality of) respective addresses 504A . . . 504N. For example, tuple Ta may include a respective plurality of addresses 504A, 506A, 508A . . . 510A. Tuple Tb may include a respective plurality of addresses 504B, 506B, 508B . . . 510B. Tuple Tc may include a respective plurality of addresses 504C, 506C, 508C . . . 510C. Tuple Tn may include a respective plurality of addresses 504N, 506N, 508N . . . 510N.

One or more addresses 504A . . . 504N may be associated, at least in part, with an initial state (e.g., Sa) of circuitry 202. For example, one or more addresses 504A . . . 504N may correspond to, and/or indicate, at least in part, ADDR A. One or more addresses 506A . . . 506N may be associated, at least in part, with one or more respective next states to which the circuitry 202 is to transition from respective current states Sa . . . Sn associated with the respective tuples Ta . . . Tn. One or more addresses 508A . . . 508N may indicate, at least in part, one or more memory addresses that may store one or more instructions that may indicate, at least in part, that circuitry 202 is to indicate, at least in part, to circuitry 300 that circuitry 202 has determined, at least in part, that one or more portions of one or more RP 190 are present in one or more portions 204. One or more addresses 510A . . . 510N may indicate, at least in part, one or more memory addresses that may store one or more instructions that may indicate, at least in part, that circuitry 202 is to perform one or more hashing, comparison, and/or related determination operations (e.g., of the type described above), and to indicate, at least in part, to circuitry 300 that circuitry 202 has determined, at least in part, that one or more portions of one or more RP 190 are present in one or more portions 204.

Each respective BM 502A . . . 502N may correspond to and/or indicate, at least in part, one or more respective subsets of the one or more portions of one or more RP 190 that circuitry 202 may be capable of detecting, at least in part. Circuitry 202 may implement, at least in part, one or more respective comparison operations, utilizing, at least in part, one or more respective BM 502A . . . 502N, to determine, at least in part, whether the one or more respective subsets of one or portions of one or more RP 190 may likely be present, at least in part, in one or more portions 204 of data stream 182.

If circuitry 202 determines, at least in part, based at least in part upon the one or more respective comparison operations, that one or more respective subsets indicated, at least in part, by a given BM may likely be present, at least in part, in one or more portions 204, circuitry 202 may undertake a more careful examination of one or more portions 204 to determine, at least in part, whether the one or more respective subsets are actually present in one or more portions 204. Depending at least in part upon the results of this determination, circuitry 202 may jump to one or more memory addresses indicated, at least in part, by one or more addresses in the respective plurality of addresses in the respective tuple that comprises the given BM.

For example, tuple (e.g., Ta) may be associated, at least in part, with an initial state (e.g., Sa) of circuitry 202. In this initial state Sa, circuitry 202 may perform one or more comparison operations, utilizing, at least in part, one or more respective BM 502A, to determine, at least in part, whether the one or more respective subsets of one or portions of one or more RP 190 indicated, at least in part, by BM 502A may likely be present, at least in part, in one or more portions 204 of data stream 182. If circuitry 202 determines, at least in part, that these one or more respective subsets are likely to be present, at least in part, in one or more portions 204, circuitry 202 may undertake a more careful examination of one or more portions 204 to determine, at least in part, whether the one or more respective subsets are actually present in one or more portions 204. For example, although not shown in the Figures, respective character sets to be compared against the one or more portions 204 (e.g., as possible state transition inputs) in the respective states of circuitry 202 may be associated with the respective tuples and may be encoded as fixed length sets (e.g., pairs) of bits that indicate, at least in part, the respective character sets. Depending at least in part upon the results of this determination, circuitry 202 may jump to one or more memory addresses 504A, 506A, 508A, or 510A.

For example, if circuitry 202 determines, at least in part, as a result at least in part of this more careful examination, that these one or more respective subsets are present in one or more portions 204, but it is not appropriate to indicate to circuitry 300 that one or more portions of one or more RP 190 are present in one or more portions 204, circuitry 202 may proceed to the one or more addresses (e.g., one or more ADDR B) associated, at least in part, with a next state (e.g., Sb) that circuitry 202 is to enter if the actual input from one or more portions 204 matches, at least in part, a state transition value (e.g., to transition to state Sb). For example, these one or more subsets may correspond, at least in part, to this state transition value. One or more addresses ADDR B may be indicated, at least in part, by one or more addresses 506A. Conversely, if one or more the actual input does not match, at least in part, this state transition value, circuitry 202 may proceed to one or more addresses 504A that indicate, at least in part, the one or more tuples Ta associated, at least in part, with initial state Sa.

In proceeding to ADDR B, circuitry 202 may enter state Sb that is associated, at least in part, with one or more tuples Tb. In state Tb, circuitry 202 may perform one or more comparison operations (e.g., generally of the type described previously in connection with BM 502A), based at least in part, upon one or more BM 502B and/or respective character sets of one or more subsets of one or more portions of one or more RP 190 that are indicated, at least in part, by one or more BM 502B. If circuitry 202 determines, based at least in part, upon these comparison operations that the one or more subsets are present in one or more portions 204, circuitry 202 may determine whether it is appropriate to indicate to circuitry 300 that one or more portions of one or more RP 190 are present in one or more portions 204 and/or whether to perform one or more hashing, comparison, and/or related determination operations (e.g., of the type described above).

If circuitry 202 determines that it is not appropriate to indicate to circuitry 300 that one or more portions of one or more RP 190 are present in one or more portions 204, but that the one or more subsets are present in one or more portions 204, circuitry 202 may proceed to the one or more addresses (e.g., ADDR C) may be indicated, at least in part, by one or more addresses 506B. Circuitry 202 then may proceed to enter state Sc and process one or more tuples Tc, generally in the manner described above in connection with tuples Ta and Tb and/or states Sa and Sb, respectively.

Conversely, if circuitry 202 determines that it is appropriate to indicate to circuitry 300 that one or more portions of one or more RP 190 are present in one or more portions 204, but that it is not appropriate to perform one or more hashing, comparison, and/or related determination operations, circuitry 202 may proceed to the one or more memory addresses at which may be stored, at least in part, one or more instructions 518A. This may result in circuitry 202 indicating to circuitry 300 that circuitry 202 has determined that one or more portions of one or more RP 190 are present in one or more portions 204. This may result, at least in part, in processing continuing by circuitry 300 in the manner described above in connection with FIG. 2.

Conversely, if circuitry 202 determines that it is appropriate to indicate to circuitry 300 that one or more portions of one or more RP 190 are present in one or more portions 204, and to perform one or more hashing, comparison, and/or related determination operations, circuitry 202 may proceed to the one or more memory addresses at which may be stored, at least in part, one or more instructions 518N. This may result in circuitry 202 performing one or more hashing, comparison, and/or related determination operations of a plurality of actual inputs from the data stream (e.g., corresponding to possible transition inputs of states of the circuitry 300). Such hashing, comparison, and/or determination operations may be carried out in the manner described previously in connection with FIG. 2. Depending upon the results of the one or more hashing, comparison, and/or related determination operations, processing may continue, as was discussed previously in connection with FIG. 2, either with circuitry 202 indicating to circuitry 300 that circuitry 202 has determined that one or more portions of one or more RP 190 are present in one or more portions 204, or with circuitry 202 returning to the initial state (e.g., Sa) associated, at least in part, with one or more addresses ADDR A.

Conversely, if circuitry 202 determines that these one or more subsets are not present in one or more portions, circuitry 202 may proceed to one or more addresses 504A that indicate, at least in part, the one or more tuples Ta associated, at least in part, with initial state Sa. In this embodiment, a tuple may comprise an association, at least in part, of one or more symbols and/or values.

In this embodiment, the one or more compiler operations may generate, at least in part, the tuples Ta . . . Tn so as to permit the circuitry 202 to avoid carrying out one or more (or any) backward program loops and/or jumps, other than, for example, one or more loops to the initial state Sa. Alternatively, without departing from this embodiment, one or more program loops and/or jumps may be permitted that may advance program control to one or more control sequences relative to a current sequence and/or that may transfer such control to any desired control sequence. For example, without departing from this embodiment, one or more addresses 504B . . . 504N may result in pattern matching operations of circuitry 202 regressing one or more patterns to be matched, but not necessarily returning to the initial state Sa. Many other variations are possible without departing from this embodiment.

Although each tuple Ta . . . Tn has been described as being associated with respective states Sa . . . Su of circuitry 202, and as comprising respective BM 502A . . . 502N and/or respective pluralities of addresses, these features of this embodiment may vary without departing from this embodiment. For example, not all of the tuples Ta . . . Tn may comprise respective bit masks, the respective numbers and types of addresses comprised in the tuples may differ from what has been described and/or may be differ from tuple to tuple, without departing from this embodiment.

Advantageously, in this embodiment, the tuples Ta . . . Tn may be implemented, at least in part, in bit vector encoding that may utilize a relatively small amount of memory and may permit the circuitry 202 to execute its operations at a speed that may be linearly proportional to the pattern being matched. Further advantageously, the encoding in this embodiment may be capable of implementing backward transitions, forward transitions, border transitions (e.g., between circuitry 202 and circuitry 300), and/or other types of transitions.

Turning now to FIG. 4, memory 170, one or more instructions 197, and/or database 191 may comprise, at least in part, one or more (and in this embodiment, a plurality of) tuples T0 . . . TM. Each of the tuples T0 . . . TM may be stored at one or more respective memory addresses ADDR 0 . . . ADDR M (e.g., in memory 170). As stated previously, circuitry 300 may execute, at least in part, one or more pattern matching threads. These one or more threads may implement, at least in part, one or more states SA . . . SM of circuitry 300. These one or more states SA . . . SM may be associated, at least in part, with the one or more portions of one or more RP 190 whose presence in data stream 182 may be determined, at least in part, by circuitry 300. The one or more states SA . . . SM may be encoded, at least in part, by and/or associated, at least in part, with the respective tuples T0 . . . TM.

In this embodiment, the respective tuples T0 . . . TM may include, at least in part, one or more respective transition input values 404A . . . 404M and/or one or more respective associated memory addresses 402A . . . 402M. The one or more memory respective addresses 402A . . . 402M in the respective tuples T0 . . . TM may be accessed by circuitry 300 depending upon whether one or more actual input values (e.g., from one or more portions 206) match, at least in part, the one or more respective transition input values 404A . . . 404M in the respective tuples T0 . . . TM.

Additionally, in this embodiment, tuples T0 . . . TM may be stored, at least in part, in memory 170 in an address sequence order that corresponds, at least in part, to the relative frequency of the transition input values (e.g., so that the most common state transition value/input is stored in the first tuple T0, the next most common such value/input is stored in the next tuple T1, and so forth). Circuitry 300 may concurrently execute multiple threads that may embody, result in execution of, implement, and/or execute, at least in part, multiple copies of one or more of the tuples T0 . . . TM and/or states SA . . . SM.

In this embodiment, one or more of the transition input values 404A . . . 404M may be indicated, at least in part, in terms of a negation of another transition input value. This negation may indicate, at least in part, that the circuitry 300 is to enter an initial state if one or more actual input values do not match, at least in part, this other transition input value that is being negated. However, the circuitry 300 may transition to a subsequent state if the one or more actual input values match, at least in part, this other transition input value that is being negated.

For example, tuple T0 may be encode, at least in part, and/or be associated, at least in part, with one or more initial states SA of circuitry 300. One or more transition input values 404A may be indicated, at least in part, in terms of a negation (e.g., “˜R”) of another transition input value (e.g., “R”). In this embodiment, this may indicate, at least in part, that circuitry 300 is to enter (or, in this case, remain in) one or more initial states SA if one or more actual input values from one or more portions 206 do not match, at least in part, the transition input value being negated (e.g., “R”). However, it may also indicate, at least in part, that circuitry 300 is to transition to the one or more next states (e.g., SB) associated with the one or more tuples (e.g., T1 and/or T3) that are associated, at least in part, with the one or more next addresses (e.g., 402A) in tuple T0. For example, in this embodiment, one or more addresses 402A may indicate, at least in part, one or more addresses ADDR 1. Accordingly, if the one or more actual input values match, at least in part, in this example, the value “R”, then the circuitry 300 may transition to one or more states SB. Otherwise, for any other input value (e.g., other than “R”), the circuitry 300 may remain in one or more states SA.

In one or more states SB, circuitry 300 may examine, at least in part, one or more portions 206 to determine, at least in part, whether one or more transition input values 404B and/or 404C may be matched, at least in part, in one or more portions 206. For example, one or more transition input values 404B may indicate, at least in part, value “O”, and one or more transition input values 404C may be indicated, at least in part, in terms of a negation (e.g., “˜M”) of another transition input value (e.g., “M”). One or more next addresses 402B and 402C may indicate, at least in part, one or more addresses ADDR M and ADDR 2, respectively. Accordingly, if the value “O” is matched, at least in part, in one or more portions 206, circuitry 300 is to transition to the one or more next states (e.g., SM) associated with the one or more tuples (e.g., TM) that are associated, at least in part, with the one or more next addresses (e.g., 402B) in tuple TM. Conversely, if the value “M” is matched in one or more portions 206, then the circuitry 300 may transition to one or more next states SC. The principles described herein may then be applied to further processing in connection with one or more states SC. Otherwise, for any other input value (e.g., other than “O” or “M”), the circuitry 300 is to transition to one or more states SA.

In state SM, the one or more next addresses 402M may indicate, at least in part, that the circuitry 300 is to determine, at least in part, that one or more RP are present in data stream 182, and is to indicate to circuitry 195, circuitry 118, CS 32, and/or HP 12 that one or more RP are present in stream 182. Circuitry 300 then may transition to either to initial state SA and/or may enter a state in which the thread being executed enters loop that does not terminate regardless of input value. This infinite loop condition may be specified, for example, by one or more special next address and/or transition input values in one or more of the tuples T0 . . . TM.

Advantageously, in this embodiment, this state encoding scheme for circuitry 300 exhibits improved memory space and processing efficiency. Also advantageously, the states of circuitry 300 may be more encoded in this embodiment using fewer tuples and/or instructions.

Thus, an embodiment may include circuitry to determine, at least in part, whether one or more reference patterns are present in a data stream in a packet flow. The circuitry may include first pattern matching circuitry communicatively coupled to second pattern matching circuitry. The first pattern matching circuitry may determine, based at least in part upon one or more deterministic pattern matching operations, whether at least one portion of the one or more reference patterns is present in the stream. If the first pattern matching circuitry determines that the at least one portion of the one or more reference patterns is present in the stream, the second pattern matching circuitry may determine, based at least in part upon one or more pattern matching threads, whether at least one other portion of the one or more reference patterns is present in the stream.

Thus, in this embodiment, examination of the data in the data stream may be carried out substantially entirely or entirely by hardware. Advantageously, this hardware may exhibit improved and/or hardened resistance to tampering by malicious programs compared to conventional software agents. Further advantageously, by using the hardware of this embodiment to perform such examination, the amount of host processor processing bandwidth and the amount of processing time consumed in carrying out such examination may be substantially reduced compared to conventional arrangements in which such software agents are employed for such examination.

Many variations, alternatives, and modifications are possible without departing from this embodiment. The accompanying claims are intended to encompass all such variations, alternatives, and modifications.

What is claimed is:

1. An apparatus comprising:
circuitry to determine, at least in part, whether one or more reference patterns are present in a data stream in a packet flow, the circuitry including first pattern matching circuitry communicatively coupled to second pattern matching circuitry, the first pattern matching circuitry being to determine, based at least in part upon one or more deterministic pattern matching operations, whether at least one portion of the one or more reference patterns is present in the data stream, and if the first pattern matching circuitry determines that the at least one portion of the one or more reference patterns is present in the data stream, the second pattern matching circuitry is to determine, based at least in part upon one or more pattern matching threads, whether at least one other portion of the one or more reference patterns is present in the data stream.

2. The apparatus of claim 1, wherein:
the one or more deterministic pattern matching operations implement, at least in part, one or more states of the first pattern matching circuitry, the one or more states being associated, at least in part, with the at least one portion of the one or more reference patterns;
the one or more states are associated, at least in part, with at least one set of transitions whose number is at least equal to a threshold value; and
the one or more deterministic pattern matching operations also implement, at least in part, one or more other states of the first pattern matching circuitry that precede, at least in part, the one or more states.

3. The apparatus of claim 2, wherein:
the one or more pattern matching threads implement, at least in part, one or more additional states, the one or more additional states being of the second pattern matching circuitry, the one or more additional states being associated, at least in part, with the at least one other portion of the one or more reference patterns; and
the one or more additional states are to be implemented, at least in part, by the second patient matching circuitry in response, at least in part, to determination, at least in part, by the first pattern matching circuitry that the at least one portion of the one or more reference patterns is present in the data stream.

4. The apparatus of claim 1, wherein:
the one or more pattern matching threads implement, at least in part, one or more states of the second pattern matching circuitry, the one or more states being associated, at least in part, with the at least one other portion of the one or more reference patterns; and
the one or more states are to be carried out, at least in part, by the second pattern matching circuitry in response, at least in part, to determination, at least in part, by the first pattern matching circuitry that a hash of a plurality of inputs results in an expected value, the plurality of inputs comprising state transition inputs of a plurality of states comprised in the one or more additional states.

5. The apparatus of claim 1, wherein:
the one or more pattern matching threads implement, at least in part, one or more states of the second pattern matching circuitry, the one or more states being associated, at least in part, with the at least one other portion of the one or more reference patterns; and
the one or more states are encoded, at least in part, by respective tuples stored in memory, the tuples including, at least in part, one or more transition input values and one or more associated memory addresses to be accessed depending upon whether one or more actual input values from the data stream matches, at least in part, the one or more respective transition input values.

6. The apparatus of claim 5, wherein:
the tuples are stored in the memory in an address sequence order that corresponds, at least in part, to relative frequency of the transition input values; and
at least one of the one or more respective transition input values is indicated, at least in part, in terms of a negation of another transition input value, the negation indicating, at least in part, that the second pattern matching circuitry is to enter an initial state if the one or more actual input values do not match, at least in part, the another transition input value, and the second pattern matching circuitry is to transition to a subsequent state if the one or more actual input values match, at least in part, the another transition input value.

7. The apparatus of claim 1, wherein:
the one or more deterministic pattern matching operations implement, at least in part, one or more states of the first pattern matching circuitry, the one or more states being associated, at least in part, with the at least one portion of the one or more reference patterns;
the one or more states are encoded, at least in part, as tuples stored in memory, the respective tuples including one or more respective bit masks and a respective plurality of addresses, the bit masks indicating, at least in part, one or more subsets of the at least one portion of the one or more reference patterns, the plurality of addresses indicating, at least in part:
one or more addresses associated, at least in part, with an initial state of the first pattern matching circuitry that the first pattern matching circuitry is to enter if an actual input from the data stream does not match, at least in part, a state transition input value; and
one or more other addresses associated, at least in part, with a next state of the first pattern matching circuitry that the first pattern matching circuitry is to enter if the actual input matches, at least in part, a state transition input value.

8. The apparatus of claim 7, wherein:
the plurality of addresses also indicate, at least in part, that:
the first pattern matching circuitry is to indicate, at least in part, to the second pattern matching circuitry that the first pattern matching circuitry has determined, at least in part, that the at least one portion of the one or more reference patterns is present in the data stream; and
the first pattern matching circuitry is to perform, at least in part, a hash of a plurality of actual inputs from the data stream.

9. The apparatus of claim 1, wherein:
the first pattern matching circuitry and the second pattern matching circuitry are comprised, at least in part, in a circuit card that is to be coupled to a circuit board.

10. A method comprising:
determining, at least in part, by circuitry, whether one or more reference patterns are present in a data stream in a packet flow, the circuitry including first pattern matching circuitry communicatively coupled to second pattern matching circuitry, the first pattern matching circuitry being to determine, based at least in part upon one or more deterministic pattern matching operations, whether at least one portion of the one or more reference patterns is present in the data stream, and if the first pattern matching circuitry determines that the at least one portion of the one or more reference patterns is present in the data stream, the second pattern matching circuitry is to determine, based at least in part upon one or more pattern matching threads, whether at least one other portion of the one or more reference patterns is present in the data stream.

11. The method of claim 10, wherein:
the one or more deterministic pattern matching operations implement, at least in part, one or more states of the first pattern matching circuitry, the one or more states being associated, at least in part, with the at least one portion of the one or more reference patterns;
the one or more states are associated, at least in part, with at least one set of transitions whose number is at least equal to a threshold value; and
the one or more deterministic pattern matching operations also implement, at least in part, one or more other states of the first pattern matching circuitry that precede, at least part, the one or more states.

12. The method of claim 11, wherein:
the one or more pattern matching threads implement, at least in part, one or more additional states, the one or more additional states being of the second pattern matching circuitry, the one or more additional states being associated, at least in part, with the at least one other portion of the one or more reference patterns; and
the one or more additional states are to be implemented, at least in part, by the second pattern matching circuitry in response, at least in part, to determination, at least in part, by the first pattern matching circuitry that the at least one portion of the one or more reference patterns is present in the data stream.

13. The method of claim 10, wherein:
the one or more pattern matching threads implement, at least in part, one or more states of the second pattern matching circuitry, the one or more states being associated, at least in part, with the at least one other portion of the one or more reference patterns; and
the one or more states are to be carried out, at least in part, by the second pattern matching circuitry in response, at least in part, to determination, at least in part, by the first pattern matching circuitry that a hash of a plurality of inputs results in an expected value, the plurality of inputs comprising state transition inputs of a plurality of states comprised in the one or more additional states.

14. The method of claim 10, wherein:
the one or more pattern matching threads implement, at least in part, one or more states of the second pattern matching circuitry, the one or more states being associated, at least in part, with the at least one other portion of the one or more reference patterns; and
the one or more states are encoded, at least in part, by respective tuples stored in memory, the tuples including, at least in part, one or more transition input values and one or more associated memory addresses to be accessed depending upon whether one or more actual input values from the data stream matches, at least in part, the one or more respective transition input values.

15. The method of claim 14, wherein:
the tuples are stored in the memory in an address sequence order that corresponds, at least in part, to relative frequency of the transition input values, and
at least one of the one or more respective transition input values is indicated, at least in part, in terms of a negation of another transition input value, the negation indicating, at least in part, that the second pattern matching circuitry is to enter an initial state if the one or more actual input values do not match, at least in part, the another transition input value, and the second pattern matching circuitry is to transition to a subsequent state if the one or more actual input values match, at least in part, the another transition input value.

16. The method of claim 10, wherein:
the one or more deterministic pattern matching operations implement, at least in part, one or more states of the first pattern matching circuitry, the one or more states being associated, at least in part, with the at least one portion of the one or more reference patterns;
the one or more states are encoded, at least in part, as tuples stored in memory, the respective tuples including one or more respective bit masks and a respective plurality of addresses, the bit masks indicating, at least in part, one or more subsets of the at least one portion of the one or more reference patterns, the plurality of addresses indicating, at least in part:
one or more addresses associated, at least in part, with an initial state of the first pattern matching circuitry that the first pattern matching circuitry is to enter if an actual input from the data stream does not match, at least in part, a state transition input value; and
one or more other addresses associated, at least in part, with a next state of the first pattern matching circuitry that the first pattern matching circuitry is to enter if the actual input matches, at least in part, a state transition input value.

17. The method of claim 16, wherein:
the plurality of addresses also indicate, at least in part, that:
the first pattern matching circuitry is to indicate, at least in part, to the second pattern matching circuitry that the first pattern matching circuitry has determined, at least in part, that the at least one portion of the one or more reference patterns is present in the data stream; and
the first pattern matching circuitry is to perform, at least in part, a hash of a plurality of actual inputs from the data stream.

18. Computer-readable memory storing one or more instructions that when executed by a machine results in operations comprising:
determining, at least in part, by circuitry, whether one or more reference patterns are present in a data stream in a packet flow, the circuitry including first pattern matching circuitry communicatively coupled to second pattern matching circuitry, the first pattern matching circuitry being to determine, based at least in part upon one or more deterministic pattern matching operations, whether at least one portion of the one or more reference patterns is present in the data stream, and if the first pattern matching circuitry determines that the at least one portion of the one or more reference patterns is present in the data stream, the second pattern matching circuitry is to determine, based at least in part upon one or more pattern matching threads, whether at least one other portion of the one or more reference patterns is present in the data stream.

19. The computer-readable memory of claim 18, wherein:
the one or more deterministic pattern matching operations implement, at least in part, one or more states of the first pattern matching circuitry, the one or more states being associated, at least in part, with the at least one portion of the one or more reference patterns;
the one or more states are associated, at least in part, with at least one set of transitions whose number is at least equal to a threshold value; and
the one or more deterministic pattern matching operations also implement, at least in part, one or more other states of the first pattern matching circuitry that precede, at least in part, the one or more states.

20. The computer-readable memory of claim 19, wherein:
the one or more pattern matching threads implement, at least in part, one or more additional states, the one or more additional states being of the second pattern matching circuitry, the one or more additional states being associated, at least in part, with the at least one other portion of the one or more reference patterns; and
the one or more additional states are to be implemented, at least in part, by the second pattern matching circuitry in response, at least in part, to determination, at least in part, by the first pattern matching circuitry that the at least one portion of the one or more reference patterns is present in the data stream.

21. The computer-readable memory of claim 18, wherein:
the one or more pattern matching threads implement, at least in part, one or more states of the second pattern matching circuitry, the one or more states being associated, at least in part, with the at least one other portion of the one or more reference patterns; and
the one or more states are to be carried out, at least in part, by the second pattern matching circuitry in response, at least in part, to determination, at least in part, by the first pattern matching circuitry that a hash of a plurality of inputs results in an expected value, the plurality of inputs comprising state transition inputs of a plurality of states comprised in the one or more additional states.

22. The computer-readable memory of claim 18, wherein:
the one or more pattern matching threads implement, at least in part, one or more states of the second pattern matching circuitry, the one or more states being associated, at least in part, with the at least one other portion of the one or more reference patterns; and
the one or more states are encoded, at least in part, by respective tuples stored in memory, the tuples including, at least in part, one or more transition input values and one or more associated memory addresses to be accessed depending upon whether one or more actual input values from the data stream matches, at least in part, the one or more respective transition input values.

23. The computer-readable memory of claim 22, wherein:
the tuples are stored in the memory in an address sequence order that corresponds, at least in part, to relative frequency of the transition input values; and
at least one of the one or more respective transition input values is indicated, at least in part, in terms of a negation of another transition input value, the negation indicating, at least in part, that the second pattern matching circuitry is to enter an initial state if the one or more actual input values do not match, at least in part, the another transition input value, and the second pattern matching circuitry is to transition to a subsequent state if the one or more actual input values match, at least in part, the another transition input value.

24. The computer-readable memory of claim 18, wherein:
the one or more deterministic pattern matching operations implement, at least in part, one or more states of the first pattern matching circuitry, the one or more states being associated, at least in part, with the at least one portion of the one or more reference patterns;
the one or more states are encoded, at least in part, as tuples stored in memory, the respective tuples including one or more respective bit masks and a respective plurality of addresses, the bit masks indicating, at least in part, one or more subsets of the at least one portion of the one or more reference patterns, the plurality of addresses indicating, at least in part:
one or more addresses associated, at least in part, with an initial state of the first pattern matching circuitry that the first pattern matching circuitry is to enter if an actual input from the data stream does not match, at least in part, a state transition input value; and
one or more other addresses associated, at least in part, with a next state of the first pattern matching circuitry that the first pattern matching circuitry is to enter if the actual input matches, at least in part, a state transition input value.

25. The computer-readable memory of claim 24, wherein:
the plurality of addresses also indicate, at least in part, that:
the first pattern matching circuitry is to indicate, at least in part, to the second pattern matching circuitry that the first pattern matching circuitry has determined, at least in part, that the at least one portion of the one or more reference patterns is present in the data stream; and
the first pattern matching circuitry is to perform, at least in part, a hash of a plurality of actual inputs from the data stream.
